(19) United States
(12) Patent Application Publication
(10) Pub. No.: US 2008/0278304 A1
(43) Pub. Date: Nov. 13, 2008

(54) Method and Apparatus for Monitoring Pressure of Vehicle Tires

(75) Inventors: Wolfgang Kiesewetter, Altdorf (DE); Jan Kipping, Stuttgart (DE); Frank Schlosser, Weissach (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/884,727

(22) PCT Filed: Feb. 4, 2006
(86) PCT No.: PCT/EP2006/000986

§ 371 Date: May 20, 2008

(30) Foreign Application Priority Data
Feb. 22, 2005 (DE) 10 2005 008 025.1

(51) Int. Cl. B60C 23/00

(52) U.S. Cl. 340/442

(57) ABSTRACT

In a method and apparatus for monitoring vehicle tire pressure a tire inflation pressure value is acquired and compared with at least one stored setpoint value; and based on the comparison result, it is determined whether the vehicle tire has an incorrect tire pressure, (particularly, an excessively low tire pressure). According to the invention when a detected activation event occurs, a current kilometer reading is acquired and is stored together with predefined information. An activation event is detected if an inflation of at least one of the tires or manual re-activation is detected.

This application is a national stage of PCT International Application No. PCT/EP2006/000986, filed Feb. 4, 2006, which claims priority under 35 U.S.C. § 119 to German Patent Application No. 10 2005 008 025.1, filed Feb. 22, 2005, the disclosure(s) of which is (are) expressly incorporated by reference herein.

### BACKGROUND AND SUMMARY OF THE INVENTION

The invention relates to monitoring the pressure of vehicle tires by comparing measured tire pressure values with stored setpoint values.

In various known devices and methods for monitoring the pressure of vehicle tires, a tire inflation pressure is acquired and compared with a stored setpoint value. Based on the result of this comparison, it is determined whether the vehicle tire pressure is incorrect tire.

For example, German patent document DE 101 30 640 A1 discloses a method and apparatus for monitoring tire pressures in a motor vehicle, in which at least one tire pressure minimum limiting value based on a setpoint value for the tire pressure is adjusted and correspondingly adapted as a function of current measured tire pressures. The described method provides two different adaptable tire pressure minimum limiting values in order to warn the driver when there is a small pressure loss and to issue an alarm to him when there is a high pressure loss. In addition, the tire pressure minimum limiting values are adapted as a function of measured temperature values. In German patent document DE 102 37 699 A1 a device for electronic tire pressure monitoring includes a wheel electronic system which determines the actual pressure and the actual temperature in a vehicle tire, a central control device, an output unit for representing the actual pressures (which are standardized to a reference temperature with predefinable setpoint pressures) and an inflation display for representing information relating to the inflation of a vehicle tire as a function of the recorded actual pressures. The setpoint pressures which are set at the reference temperature can be converted to setpoint pressures at the current actual temperature of the vehicle tires by means of the control device and can be represented on an inflation display.

One object of the present invention is to provide a tire pressure monitoring method which reliably and promptly informs the driver about a drop in the tire pressure and permits diagnostics.

Another object of the invention is to provide an associated device for monitoring the pressure of vehicle tires.

These and other objects and advantages are achieved by the tire pressure monitoring method according to the invention, in which a current kilometer reading is obtained whenever a detected activation event occurs, and is stored together with predefined information. An activation event is detected if there is an inflation of at least one of the tires of the vehicle, or if manual re-activation (reset) is detected. Inflation of a tire is to be understood as meaning either an increase or a decrease in the tire pressure. The presence of an activation event can also be associated with rising of the pressure above a predefinable threshold value or dropping of the pressure at a predefinable minimum number of tires. For example, an activation event is detected if an increase in pressure or a drop in pressure by a predefinable minimum value takes place at least two tires, if the tire pressure values which are then present are within a predefinable permissible pressure value range. As a result, the last events can advantageously be traced with respect to the tire pressure, and it is possible to react appropriately to possible customer complaints. Inflation of the tires is detected, for example, if the tire pressure in at least one tire is increased by a predefined threshold value, for example by 0.2 bar. Manual re-activation is triggered, for example, by activation of a manual activation means as part of an operator control menu. Threshold values which are stored in order, for example, to output warning messages are adapted to new tire pressure values by a detected activation event.

In one embodiment of the method according to the invention, for example the acquired tire pressure value and an acquired tire temperature are stored together with the kilometer reading as predefined information. As a result, each entry in an activation memory comprises the kilometer reading, the tire pressure values and the tire temperatures for each of the vehicle tires.

In a further embodiment of the method according to the invention, a predefinable number of activation events, preferably between three and ten activation events, are stored and are read out for diagnostics.

A device for monitoring vehicle tire pressure according to the invention comprises at least one tire sensor unit which acquires, for an associated tire, a tire inflation pressure value, and transmits it to an evaluation and control unit. The latter compares the acquired tire pressure value with at least one stored setpoint value and, based on the result, determines whether the vehicle tire has an incorrect tire pressure, in particular an excessively low tire pressure. According to the invention, when an activation event is detected the evaluation and control unit determines a current kilometer reading and stores the kilometer reading which is determined, together with predefined acquired information, in a memory unit. The evaluation and control unit detects an activation event if at least one of the tires is inflated or manual re-activation is detected.

In one embodiment of the device according to the invention for monitoring the pressure of vehicle tires, the at least one tire sensor unit acquires the temperature in the associated tire and transmits it to the evaluation and control unit which stores the tire temperature and the tire pressure value as predefined acquired information in the memory unit.

In a further embodiment of the device according to the invention, the evaluation and control unit stores the kilometer readings and the associated information for a predefinable number of activation events in the memory unit.

In a further embodiment, the device according to the invention comprises an interface via which the kilometer readings and the associated stored information can be read out from the memory unit for diagnostics.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a device for monitoring the pressure of vehicle tires; and

FIG. 2 is a flowchart which shows the steps of a method for monitoring the pressure of vehicle tires.

### DETAILED DESCRIPTION OF THE DRAWINGS

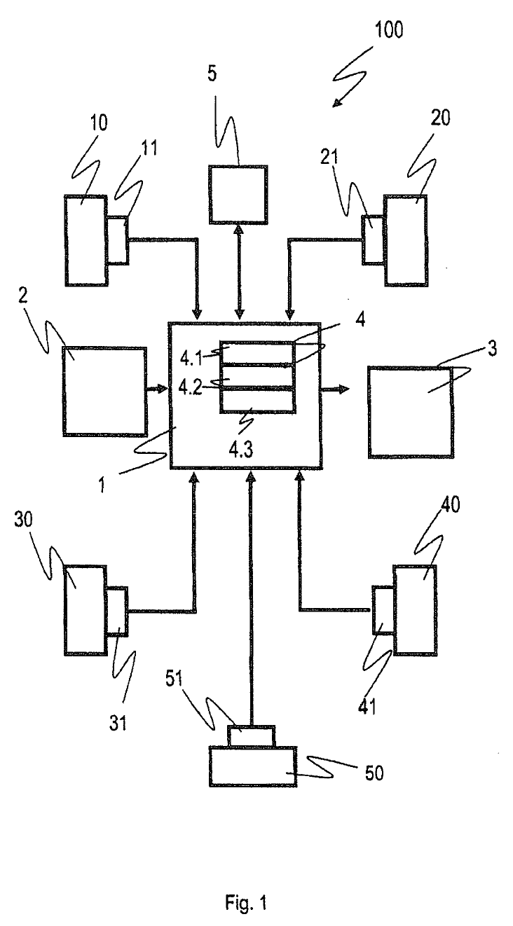

As is shown in FIG. 1, the device 100 for monitoring the pressure of vehicle tires comprises, for each tire 10, 20, 30, 40, 50, a tire sensor unit 11, 21, 31, 41, 51 which, determines for the associated tire, a tire pressure value which describes the tire inflation pressure, and a tire temperature. The tire sensor units 11, 21, 31, 41, 51 transmit the acquired values (for example, via wireless transmission) to an evaluation and control unit 1 which compares the acquired tire pressure value with at least one stored setpoint value. Based on the comparison result, it then determines whether one of the vehicle tires 10, 20, 30, 40, 50 has an incorrect tire pressure, in particular an excessively low tire pressure. In the illustrated exemplary embodiment, the evaluation and control unit 1 takes into account the tire temperature in the determination of the tire pressure values and compensates for the influence of temperature. The evaluation and control unit 1 outputs visual or audible warning messages via an output unit 3 if the acquired incorrect tire pressure reaches or exceeds predefined threshold values.

When an activation event is detected the evaluation and control unit 1 determines a current kilometer reading and stores it in a memory unit 4, together with predefined acquired information (such as, for example, the tire pressure value and the tire temperature).

The evaluation and control unit 1 detects an activation event if at least one of the tires is inflated or a manual re-activation is detected. In particular, an activation event is detected if the pressure rises or drops significantly at least two tires, insofar as the tire pressure values are in the permissible pressure value range. The stored kilometer (or mileage) readings and the associated information are read out of the memory unit 4 via an interface 5 for diagnostics. As a result, the last events can be traced with respect to the tire pressure. The evaluation and control unit 1 detects inflation if, for example, the tire pressure in at least one tire is increased by a predefined threshold value (for example, by 0.2 bar). Manual re-activation is triggered, for example, by activating a manual activation means 2 as part of an operator control menu. Threshold values which are stored in order, for example, to output warning messages are adapted to new tire pressure values by a detected activation event.

In the illustrated exemplary embodiment, the memory unit 4 comprises three memory locations 4.1, 4.2, 4.3 in each of which an activation event can be stored. Each entry in a memory location 4.1, 4.2, 4.3 comprises the kilometer reading, the tire pressure values and the tire temperatures for each of the vehicle tires 10, 20, 30, 40, 50.

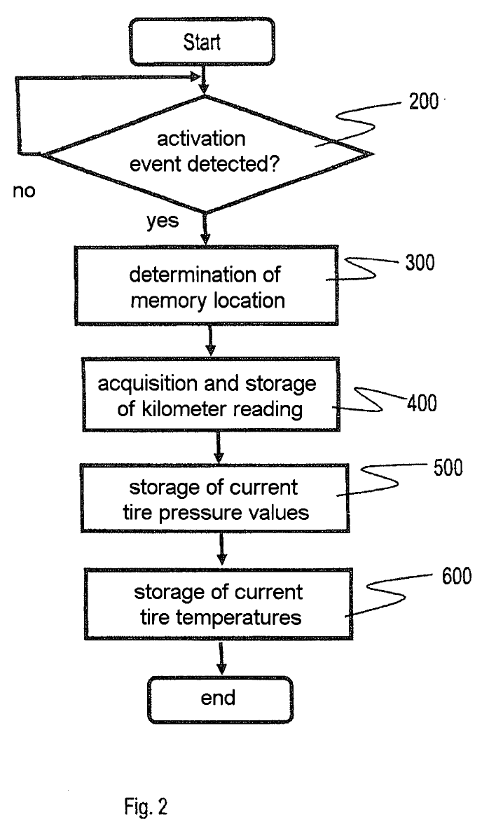

As is apparent from FIG. 2, the method according to the invention for monitoring the pressure of vehicle tires checks, after the start in step 200, whether an activation event has occurred. If no activation event is detected in step 200, the method returns to the starting point. If an activation event is detected in step 200 (e.g., inflation of at least one of the tires 10, 20, 30, 40, 50 or manual re-activation), in step 300 the memory location 4.1, 4.2 or 4.3 in the memory unit 4 in which the activation event is to be stored is determined. In the illustrated exemplary embodiment, the memory unit 4 comprises three memory locations 4.1, 4.2, 4.3, which are written to in succession. If all the memory locations are occupied, the contents of the memory locations 4.1, 4.2, 4.3 are overwritten by new activation events starting with the oldest memory contents. As a result, the last three activation events are always stored in the memory unit 4.

In step 400, the current kilometer reading of the vehicle is acquired and stored in the memory location defined in step 300. In step 500, the currently acquired tire pressure values of the tires 10, 20, 30, 40, 50 are stored in the memory location which is defined in step 300. In step 600, the currently acquired tire temperatures at the tires 10, 20, 30, 40, 50 are stored in the memory location which is defined in step 300. In alternative embodiments which are not illustrated, the steps 400 to 600 can be carried out in a different sequence or simultaneously.

The activation events which are stored in the memory unit 4 can be read out via the interface 5 for diagnostic purposes, for example in a workshop. As a result, the last events can be traced in relation to the tire pressure and it is possible to react appropriately to possible customer complaints.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A method for monitoring vehicle tire pressure, in which method a tire inflation pressure is acquired and compared with at least one stored setpoint value, and based on a result of the comparison, it is determined whether the vehicle tire has an incorrect tire pressure, wherein:
when a detected activation event occurs, a current kilometer reading is acquired and is stored together with predefined information; and
an activation event is detected if inflation of at least one of the tires or manual re-activation is detected.

11. The method as claimed in claim 10, wherein an activation event is detected if i) at least two tires undergo a significant rise in pressure or drop in pressure, and ii) the tire pressure values are in the permissible pressure value range.

12. The method as claimed in claim 10, wherein the acquired tire pressure value and an acquired tire temperature are stored as predefined information.

13. The method as claimed in claim 10, wherein a predefinable number of activation events are stored and are read out for diagnostics.

14. The method as claimed in claim 13, wherein between three and ten activation events are stored.

15. A device for monitoring vehicle tire pressure, comprising:
an evaluation and control unit; and
at least one tire sensor unit which acquires, for an associated tire, a tire inflation pressure value and transmits it to the evaluation and control unit; wherein,
the evaluation and control unit compares the acquired tire pressure value with at least one stored setpoint value and, based on a comparison result, determines whether the vehicle tire has an incorrect tire pressure;
when an activation event is detected, the evaluation and control unit determines a current kilometer reading and stores it together with predefined acquired information in a memory unit; and
the evaluation and control unit detects an activation event if at least one tire is inflated or manual re-activation is detected.

16. The device as claimed in claim 15, wherein the at least one tire sensor unit acquires the temperature in the associated tire and transmits it to the evaluation and control unit which stores the tire temperature and the tire pressure value as predefined acquired information in the memory unit.

17. The device as claimed in claim 15, wherein the evaluation and control unit stores the kilometer readings and the associated information for a predefinable number of activation events in the memory unit.

18. The device as claimed in claim 15, further comprising an interface via which the kilometer readings and the associated stored information can be read out for diagnostic purposes.

19. A method for evaluating vehicle tire inflation pressure by measuring tire pressure and comparing measured pressure values with a stored setpoint, wherein said method further comprises:
detecting occurrence of an activation event whenever there occurs at least one of a tire inflation, a manual reset, or a rise or fall of tire pressure beyond definable threshold values;
upon detection of an activation event, storing in a memory a current mileage reading for the vehicle, together with predefined information comprising a current measured tire pressure value; and
storing in said memory mileage values and associated predefined information for each of a predefined number of activation events; and
diagnosing said tire pressure based on information stored in said memory.

20. The method according to claim 19, wherein said predefined information further comprises tire temperature.
